(19) United States
(12) Patent Application Publication
(10) Pub. No.: US 2024/0177449 A1
(43) Pub. Date: May 30, 2024

(54) Copy-Protected Image Display System

(71) Applicant: Hung-Cheng Kuo, Hsinchu City (TW)

(72) Inventor: Hung-Cheng Kuo, Hsinchu City (TW)

(21) Appl. No.: 18/070,829

(22) Filed: Nov. 29, 2022

(51) Int. Cl. G06V 10/75; G02B 27/01; G06T 9/00; H04L 9/08

(52) U.S. Cl. CPC G06V 10/751; G02B 27/0172; G06T 9/00; H04L 9/0869; G02B 2027/0178

(57) ABSTRACT

A copy-protected image display system is provided to include an eyeglasses display device, and an image content server that stores a source image, and device information that corresponds to the eyeglasses display device. The image content server introduces a small data change into the source image based on the device information to obtain a first modified image, converts the first modified image into a second modified image based on an image modification rule, and transmits the second modified image to the eyeglasses display device through a data transceiving device. The eyeglasses display device converts the second modified image back to the first modified image, and displays the first modified image.

### BACKGROUND OF THE DISCLOSURE

### Field of the Disclosure

The disclosure relates to copy protection, and more particularly to a copy-protected image display system

### Description of Related Art

In order to protect digital image content from being copied illegally, image content providers (e.g., streaming service providers) may encode or encrypt the digital image content before transmission to a user-end computer device. After receipt of the encoded/encrypted image data, the user-end computer device performs decoding or decryption to obtain the digital image content, and transmits the digital image content to a display panel for display thereby.

However, such an approach is unable to prevent the digital image content from being illegally copied if a person with bad intentions uses the user-end computer device to pirate the digital image content after the user-end computer device has decoded/decrypted the encoded/encrypted image data. In addition, the image content providers are unable to find any information about the person who illegally copied the digital image content from the pirated digital image content.

### SUMMARY OF THE DISCLOSURE

Therefore, an object of the disclosure is to provide a copy-protected image display system that can alleviate at least one of the drawbacks of the prior art.

According to the disclosure, the copy-protected image display system is adapted for use with a data transceiving device to present an image, and includes an eyeglasses display device and an image content server. The eyeglasses display device is configured for image display, and is to be communicatively connected to the data transceiving device. The image content server stores a source image corresponding to a plurality of image pixels and device information of the eyeglasses display device. The image content server is to be communicatively connected to the data transceiving device. The image content server is configured to introduce a data change to the source image based on the device information, so as to obtain a first modified image that corresponds to the image pixels. For each of the image pixels, a difference between the first modified image and the source image at the image pixel is smaller than a first threshold pixel value. For a first portion of the image pixels, the difference between the first modified image and the source image at each of the image pixels in the first portion is greater than zero. The image content server is configured to convert the first modified image into a second modified image based on an image modification rule. For a second portion of the image pixels, a difference between the second modified image and the first modified image at each of the image pixels in the second portion is greater than a second threshold pixel value that is greater than the first threshold pixel value. The image content server is configured to transmit the second modified image to the eyeglasses display device through the data transceiving device. The eyeglasses display device includes a decoder circuit that is configured to convert the second modified image back to the first modified image, and is configured to display the first modified image.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a schematic diagram illustrating an embodiment of a copy-protected image display system according to the disclosure.

FIG. 2 is a block diagram illustrating the embodiment.

FIG. 3 is a plot illustrating a difference between a desired voltage-luminance relationship and a native voltage-luminance relationship of a display pixel.

FIG. 4 is a flow chart illustrating steps of a method to be implemented by the embodiment of the copy-protected image display system according to the disclosure.

FIG. 5 is a schematic diagram illustrating an example in obtaining a first modified image according to the disclosure.

FIG. 6 is a plot exemplarily illustrating a desired predetermined grayscale-luminance relationship and possible modified grayscale-luminance relationships.

### DESCRIPTION OF NON-LIMITING EMBODIMENTS OF THE DISCLOSURE

Before the disclosure is described in greater detail, it should be noted that where considered appropriate, reference numerals or terminal portions of reference numerals have been repeated among the figures to indicate corresponding or analogous elements, which may optionally have similar characteristics.

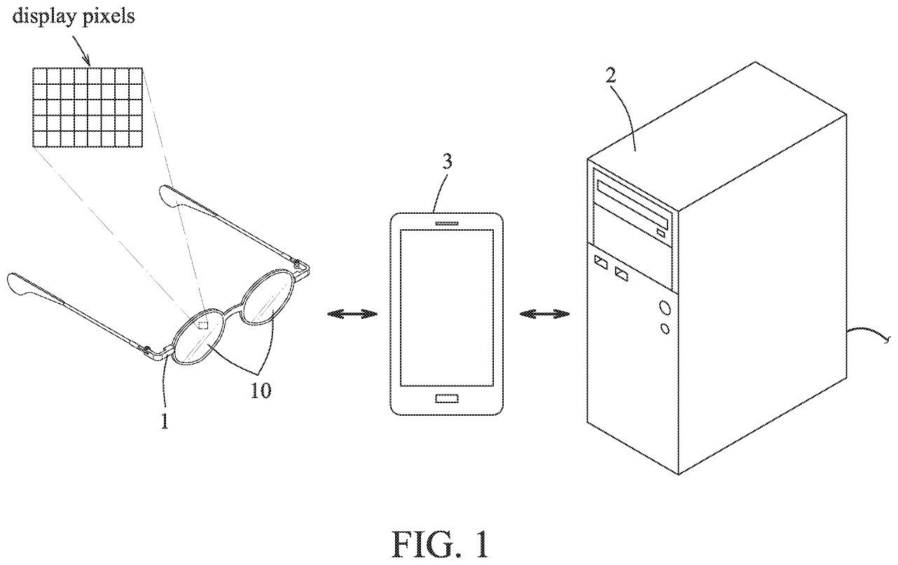

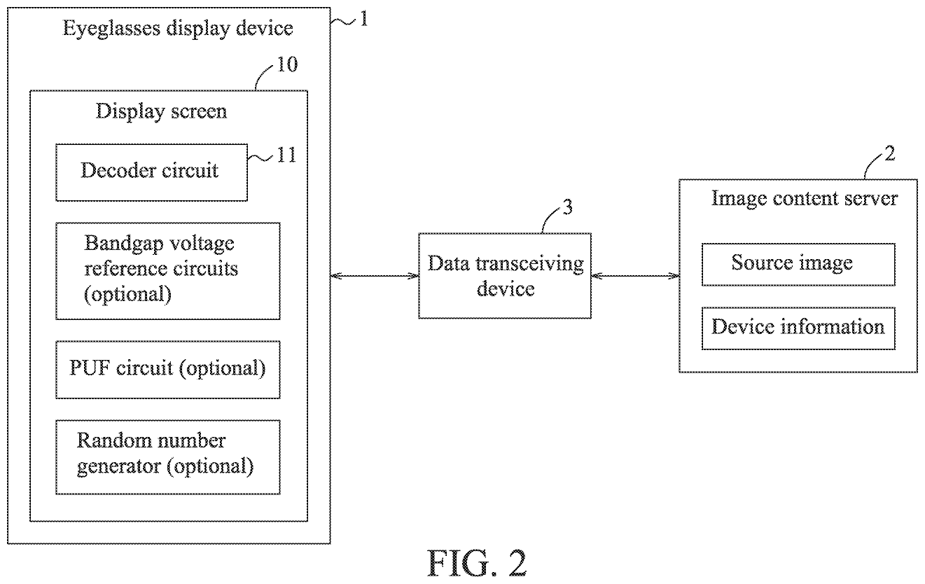

Referring to FIGS. 1 and 2, an embodiment of a copy-protected image display system according to this disclosure includes an eyeglasses display device 1 and an image content server 2, and is adapted for use with a data transceiving device 3 to present an image, which may be either a still image or a video.

The eyeglasses display device 1 includes one or more display screens 10 for image display. In some embodiments, each display screen 10 may be a display panel that is made using, for example but not limited to, liquid crystal display (LCD) technology, micro light-emitting diode (MicroLED) technology, quantum dot (QD) technology, organic light-emitting diode (OLED) technology, etc. In some embodiments, the eyeglasses display device 1 may include an image projector (not shown) that projects images onto the display screen(s) 10. For ease of explanation, only one display screen 10 will be described in the following embodiment(s), and the display screen 10 is exemplified as a display panel that has a plurality of display pixels arranged in an array (e.g., a 1920×1080 array) to display an image that is composed of multiple image pixels each having a respective pixel value, but this disclosure is not limited in this respect. The eyeglasses display device 1 is communicatively connected to the data transceiving device 3 through wired connection (e.g., using the universal serial bus (USB) technology) or wireless communication (e.g., using WiFi, Bluetooth®, etc.).

The image content server 2 may be a server of a content provider that provides a subscription streaming service, and is communicatively connected to the data transceiving device 3 through a network (e.g., the Internet). The image content server 2 stores a source image (e.g., a video of a movie, a drama, a TV show, etc.) to be provided to the eyeglasses display device 1 that is owned by a user (e.g., a subscriber of the streaming service), and multiple pieces of device information that respectively correspond to a plurality of display devices (including the eyeglasses display device 1).

In some embodiments, the device information that corresponds to the eyeglasses display device 1 may include a serial number of the eyeglasses display device 1. In some embodiments, the device information that corresponds to the eyeglasses display device 1 may include one or more display-related random factors that will be used for image modification and that correspond to the eyeglasses display device 1.

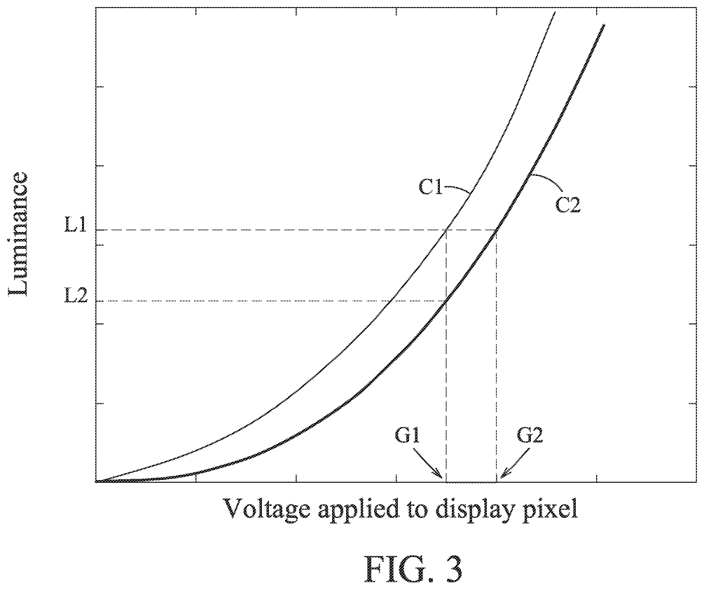

In one example, since each of the display pixels of the display screen 10 has a native (or inherent) voltage-luminance relationship in reality, which is generally non-ideal and random in nature, the native voltage-luminance relationships of the display pixels may serve as the display-related random factors for the eyeglasses display device 1. The display pixels of the display screen 10 correspond in position to the image pixels of the source image to be displayed by the display screen 10, so each of the image pixels corresponds to the native voltage-luminance relationship of one of the display pixels that corresponds in position to the image pixel. Referring to FIG. 3, the display pixels are usually designed to have the same desired voltage-luminance relationship (represented by a curve C1). However, in actual production, each of the display pixels may have a respective native voltage-luminance relationship (represented by a curve C2) that is close to but different from the desired voltage-luminance relationship. In addition, different display pixels may have either the same or different native voltage-luminance relationships, and so the display screen 10 would have a unique distribution or combination of native voltage-luminance relationships. Since the difference between the native voltage-luminance relationship and the desired voltage-luminance relationship may result from unavoidable physical processing limitations (e.g., different positions in a processing chamber may lead to different processing conditions, such as gas flow, pressure, temperature, etc., although the differences may be small), the native voltage-luminance relationships of the display pixels are random in nature, and can thus be used as the display-related random factors of the device information that corresponds to the eyeglasses display device 1 including the display screen 10. As a variation, the display-related random factors of the device information may include a set of differences between the desired voltage-luminance relationship and the native voltage-luminance relationships of the display pixels. Furthermore, since the distribution or combination of the native voltage-luminance relationships of the display pixels is unique for the display screen 10, it can be used to identify the display screen 10 as well as the eyeglasses display device 1 that includes the display screen 10. Therefore, the distribution or combination of the native voltage-luminance relationships of the display pixels can be directly used as the device information that corresponds to the eyeglasses display device 1.

In one example, the device information relates to electric characteristics of the eyeglasses display device 1. For instance, the display screen 10 of the eyeglasses display device 1 may include multiple bandgap voltage reference circuits that are designed to have the same voltage output. However, in practice, the voltage outputs of the bandgap voltage reference circuits may have tiny random differences due to uncontrollable variations in fabrication processes. The display screen 10 may further include comparators (not shown) to compare the voltage outputs of the bandgap voltage reference circuits, and the outputs of the comparators cooperatively form a code that represents the random differences and that can be used as the display-related random factor of the device information corresponding to the eyeglasses display device 1.

In one embodiment, the eyeglasses display device 1 may include a physically unclonable function (PUF) circuit, and the device information of the eyeglasses display device 1 relates to physical characteristics of the PUF circuit. For example, the PUF circuit may be a circuit of delay PUF that exploits random variations in delays of wires and gates on silicon (the variations in delays are random because of randomness during fabrication, but are fixed after the fabrication), and a result of a race condition set up in the PUF circuit can be used as a display-related random factor of the device information that corresponds to the eyeglasses display device 1. Since the PUF circuits come in a variety of types, which should be familiar to one skilled in the art, this disclosure is not limited to a specific type of the PUF circuits, and details of the different types of the PUF circuits are omitted herein for the sake of brevity.

In one embodiment, the display screen 10 of the eyeglasses display device 1 may include a random number generator that is configured to generate one or more random numbers. In a first scenario, the random number generator generates multiple random numbers respectively for the display pixels of the display screen 10 every time the eyeglasses display device 1 is turned on, and the eyeglasses display device 1 transmits the random numbers along with correspondences between the random numbers and the display pixels to the image content server 2 through the data transceiving device 3, so that the image content server 2 makes the random numbers serve as the display-related random factors of the device information that corresponds to the eyeglasses display device 1. In a second scenario, the random number generator generates a random number that corresponds to the eyeglasses display device 1, and the eyeglasses display device 1 transmits the random number to the image content server 2 through the data transceiving device 3, so that the image content server 2 makes the random number provided by the eyeglasses display device 1 serve as the display-related random factor of the device information that corresponds to the eyeglasses display device 1. In some implementations, the first and second scenarios are combined together. That is, the random number generator generates multiple random numbers respectively for the display pixels of the display screen 10, and also generates a random number that corresponds to the eyeglasses display device 1.

In some embodiments, the eyeglasses display device 1 may be provided by the content provider to the user who has subscribed to the streaming service with the content provider, so the image content server 2 of the content provider has the corresponding device information. In some embodiments, the user may provide the device information that corresponds to the eyeglasses display device 1 to the image content server 2 through a registration procedure. In some embodiments, the eyeglasses display device 1 may automatically transmit the corresponding device information to the image content server 2 when the communication between the eyeglasses display device 1 and the image content server 2 is established through the data transceiving device 3.

The data transceiving device 3 communicatively interconnects the eyeglasses display device 1 and the image content server 2, and may be realized as, for example but not limited to, a desktop computer, a smartphone, a tablet computer, a notebook computer, or any other suitable electronic device that is capable of data transmission with the eyeglasses display device 1 and the image content server 2. In this embodiment, the data transceiving device 3 is operable by the user to request the source image from the image content server 2, and does not require strong computational capabilities. In this embodiment, the eyeglasses display device 1 serves as an external display that is connected to the data transceiving device 3, so the eyeglasses display device 1 does not need a processor of its own, and material cost and power consumption of the eyeglasses display device 1 can thus be reduced.

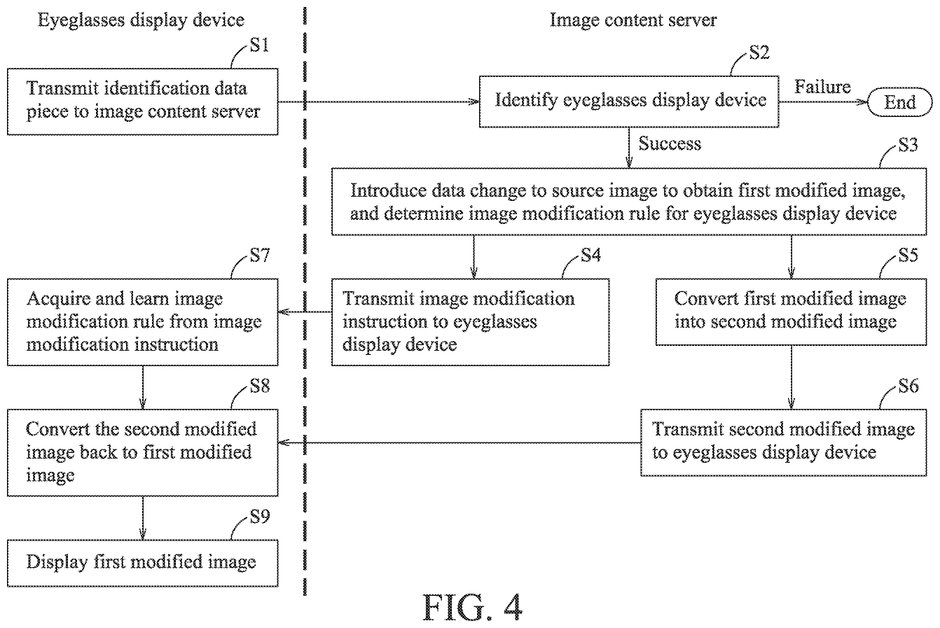

FIG. 4 illustrates an exemplary flow to be implemented by the copy-protected image display system as shown in FIGS. 1 and 2 to present an image.

In step S1, the data transceiving device 3 makes a request for the source image with the image content server 2, receives an identification data piece from the eyeglasses display device 1, and transmits the identification data piece to the image content server 2 (namely, the eyeglasses display device 1 transmits the identification data piece to the image content server 2 through the data transceiving device 3) for the image content server 2 to identify the eyeglasses display device 1 (step S2). In practice, the identification data piece may be identical to at least a part of the device information that corresponds to the eyeglasses display device 1, where the part is used for identification (e.g., the serial number, the distribution or combination of the native voltage-luminance relationships of the display pixels, the outputs of the comparators used to compare the voltage outputs of the bandgap voltage reference circuits, the result of the race condition set up in the PUF circuit, the random number(s) generated by the random number generator of the display screen 10, etc.). In some implementations, the identification data piece may be stored in a storage module (not shown) of the eyeglasses display device 1 (e.g., in the case where the identification data piece is the serial number or the distribution/combination of the native voltage-luminance relationships of the display pixels). In some implementations, the identification data piece may be generated every time the eyeglasses display device 1 is turned on. For example, in the case where the identification data piece is the outputs of the comparators used to compare the voltage outputs of the bandgap voltage reference circuits, the comparators may generate the outputs that serve as the identification data piece every time the eyeglasses display device 1 is turned on. For example, in a case where the identification data piece is the result of the race condition set up in the PUF circuit, the PUF circuit may generate the result of the race condition that serves as the identification data piece every time the eyeglasses display device 1 is turned on.

Upon determining that the identification data piece matches the device information (i.e., matching the part of the device information that is used for identification), which means that the image content server 2 successfully identified the eyeglasses display device 1, the flow goes to step S3, where the image content server 2 introduces a data change to the image pixels of the source image based on the device information, so as to obtain a first modified image that is composed of the image pixels of the source image with a different combination of pixel values. In other words, the first modified image is obtained by adjusting pixel values of the image pixels of the source image. In this embodiment, the data change is intended to be made as an embedded identifier of the first modified image, and to be hardly perceivable by a user of the eyeglasses display device 1, so that the content provider can find out the target to which the first modified image is provided (i.e., the eyeglasses display device 1 is the ‘target device’ that the first modified image is targeted at and is provided to) based on a difference between the first modified image and the source image (i.e., the data change), while a viewing experience of the user will not be affected.

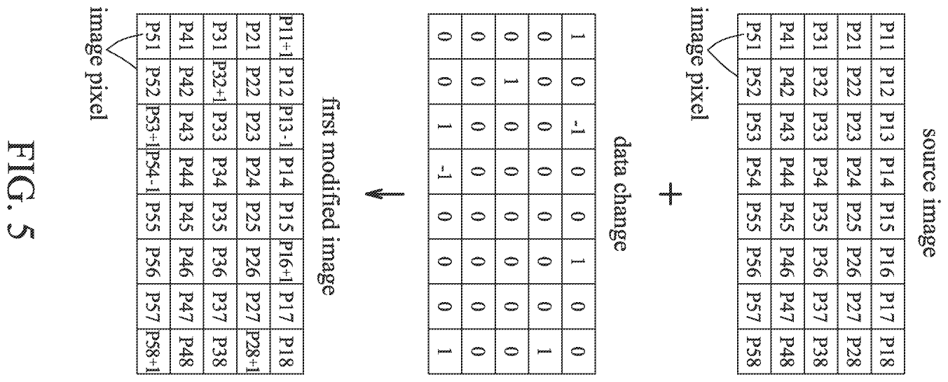

Therefore, for each of the image pixels, a difference between the first modified image and the source image with respect to the pixel value of the image pixel (hereinafter referred to as “difference between the first modified image and the source image at the image pixel”) is configured to be smaller than a first threshold pixel value; and for some of the image pixels (referred to as a first portion of the image pixels hereinafter), the difference between the first modified image and the source image at each of the image pixels in the first portion is greater than zero. For the display screen 10 of the eyeglasses display device 1, the image content server 2 may determine which image pixels are to be part of the first portion based on the corresponding device information. For example, for different display devices with different device information, the image content server 2 can determine different combinations of the image pixels to be in the first portion. For example, the image content server 2 may classify the pieces of the device information that correspond to different display devices into multiple groups, and determine different combinations of the image pixels to be in the first portion for different groups. In one example where the device information relates to the physical characteristics of the PUF circuit or includes the random number that corresponds to the eyeglasses display device 1, and the PUF circuit has 1,024 possible outcomes (although a single PUF circuit can provide only a specific one out of 1,000 possible outcomes) or the random number has 1,024 possible values, the image content server 2 may be configured to have 1,024 different combinations of the image pixels to be included in the first portion respectively for the 1,024 possible outcomes or values (i.e., the pieces of the device information are classified into 1,024 groups). In some embodiments, the image pixels in the first portion correspond to those of the display pixels that are proximate to edges of the display screen 10, so as to further reduce the chances that the user perceives the change made to the source image. Then, the image content server 2 may add 1, −1 or other small values that are smaller than the first threshold pixel value to the pixel values of the image pixels in the first portion, while the pixels values of the other image pixels remain unchanged. In such a scenario, according to some embodiments, the first threshold pixel value may be set to be, for example but not limited to, between 2 and 5 (inclusive of 2 and 5) in absolute value. FIG. 5 illustrates an example of the aforesaid operation, where the source image is exemplified to have multiple image pixels arranged in an 8×5 array, and the pixel values of the image pixels are denoted as P11, P12, . . . , P18, P21, P22, . . . , P28, . . . , P51, P52, . . . , P58. The image content server 2 may randomly generate multiple kinds (e.g., 1,024 kinds) of data changes, each corresponding to a respective distribution of small values (i.e., 1, −1, and/or other small values) in the data change with respect to edge portions of the source image, and determine and record one kind of data change for the eyeglasses display device 1 based on the corresponding device information. Then, the image content server 2 introduces the data change thus determined to the source image to obtain the first modified image.

Referring to FIG. 3 again, in one example, the image content server 2 may determine the data change based on a difference between the desired voltage-luminance relationship (e.g., the curve C1) and the native voltage-luminance relationship of each display pixel (e.g., the curve C2). The display screen 10 is usually configured to have a plurality of grayscale values that respectively correspond to different voltage levels, thereby controlling luminance levels of the display pixels. The correspondences between the grayscale values and the voltage levels are usually determined based on the desired voltage-luminance relationship, so a display pixel might be unable to provide a desired luminance for a given grayscale value in view of the difference between the desired voltage-luminance relationship and the native voltage-luminance relationship of the display pixel. In a case where the device information that corresponds to the eyeglasses display device 1 and that is stored in the image content server 2 includes the correspondences between the grayscale values and the voltage levels, the desired voltage-luminance relationship, and the native voltage-luminance relationship of the display pixels, the image content server 2 may perform luminance compensation on the display pixels by adjusting the pixel values of the image pixels of the source image, so as to make each of the display pixels, which actually has the native voltage-luminance relationship, appear to have a predetermined grayscale-luminance relationship that is defined with respect to the source image (i.e., a grayscale-luminance relationship that is determined based on the desired voltage-luminance relationship), and obtain the first modified image accordingly (i.e., the adjustments to the pixels values serve as the data change). As exemplified in FIG. 3, when an image pixel of the source image has a pixel value of G1, a corresponding display pixel is expected to have a luminance of L1 because the predetermined grayscale-luminance relationship is determined based on the desired voltage-luminance relationship (i.e., the curve C1). However, because of the difference between the desired voltage-luminance relationship and the native voltage-luminance relationship of the display pixel, for this display pixel, the corresponding luminance at the pixel value G1 would be L2. In order to compensate for the difference in terms of luminance, the image content server 2 may adjust the pixel value of the image pixel from G1 to G2, so that the display pixel can provide the luminance L1 when the pixel value of the image pixel of the source image is originally G1. In this case, the data change at the image pixel would be (G2−G1), which is made smaller than the first threshold pixel value (e.g., making the first threshold pixel value serve as an upper limit for the adjustment of the pixel value). In the scenario of using luminance compensation to determine the data change, the first threshold pixel value may be set to be, for example but not limited to, between 1/60 and ⅙ of a maximum value that can be represented by a number of bits of the pixels values. For instance, when the pixel values are represented by 8 bits, the maximum value that can be represented by 8 bits is 255, and the first threshold pixel value may be set to be between 255/60 and 255/6, namely, one of the numbers from 5 to 42. The luminance compensation may optimize image quality perceived by the user, so the viewing experience would not be adversely affected, but may be promoted instead. In addition, since the display screen 10 has a unique distribution or combination of the native voltage-luminance relationships of the display pixels, the correspondences between the pixels values of the image pixels of the source image and the pixels values of the image pixels of the first modified image would be unique, so the content provider can find the target device the first modified image is provided to (i.e., the eyeglasses display device 1) based on a difference between the first modified image and the source image (i.e., the data change).

Referring to FIGS. 1, 2 and 4 again, the image content server 2 further determines an image modification rule for the eyeglasses display device 1 in step S3, where the image modification rule is to be used to perform further modification on the first modified image in a later step. In some embodiments, the image modification rule includes a plurality of pixel modification rules that respectively correspond to the image pixels of the first modified image, and each of the pixel modification rules is used to change the pixel value of the corresponding image pixel. Then, the flow goes to step S4 and step S5. In step S4, the image content server 2 transmits an image modification instruction that contains information related to the image modification rule to the eyeglasses display device 1 through the data transceiving device 3. In step S5, the image content server 2 converts the first modified image into a second modified image according to the image modification rule, where the second modified image is composed of the image pixels of the first modified image with a different combination of pixel values. In other words, the second modified image is obtained by changing the pixel values of the image pixels of the first modified image according to the image modification rule. An object of converting the first modified image into the second modified image is to drastically change image content of the first modified image, so that one cannot easily recognize the original content of the source image from the second modified image. In order to achieve this object, for some of the image pixels (referred to as a second portion of the image pixels hereinafter), a difference between the second modified image and the first modified image at each of the image pixels in the second portion is greater than a second threshold pixel value that is greater than the first threshold pixel value. The second threshold pixel value may be set to be, for example but not limited to, between 20% and 100% of the maximum value that can be represented by the number of bits of the pixel values. It is noted that the image modification rule may involve all of the image pixels of the first modified image, but the resultant differences between the second modified image and the first modified image at some of the image pixels may be no greater than the second threshold pixel value. In other words, it is possible that the second portion of the image pixels is not a portion specifically selected to be modified using the image modification rule, but, instead, it is the image modification rule that leads to the formation or composition of the second portion of the image pixels.

In some embodiments, the image content server 2 is capable of performing each of multiple types of predefined encoding operations using software, firmware, hardware circuits, or a combination thereof. Each of the pixel modification rules may include one or more of the predefined encoding operations to be performed on the corresponding image pixel (i.e., the image content server 2 may combine multiple ones of these predefined encoding operations to form the pixel modification rule for the image pixel). In some embodiments, different image pixels may correspond to different pixel modification rules (i.e., different combinations of the predefined encoding operations), but this disclosure is not limited in this respect.

In some embodiments, one of the predefined encoding operations is to perform a circular shift on the pixel value (referred to as first predefined encoding operation hereinafter). As an example, the image content server 2 may perform a right circular shift by four positions in the first predefined encoding operation, so that, for example, a pixel value of 00001111 (i.e., 15 in decimal) would be converted to 11110000 (i.e., 240 in decimal), and a pixel value of 00001110 (i.e., 14 in decimal) would be converted to 11100000 (i.e., 224 in decimal). In some embodiments, the first predefined encoding operation may be performed on some of the pixel values of the image pixels of the first modified image.

In some embodiments, one of the predefined encoding operations is to subtract a predetermined value that is greater than the second threshold pixel value from the pixel value (referred to as second predefined encoding operation hereinafter). For example, the image content server 2 may subtract a predetermined value of 128 from an 8-bit pixel value in the second predefined encoding operation. In such a case, when the pixel value is smaller than the predetermined value, a borrow operation may be used (e.g., when the subtraction operation is performed on an 8-bit pixel value of 15 (00001111 in binary), the outcome would be 15+2⁸−128=143). In some embodiments, the second predefined encoding operation may be performed on some of the pixel values of the image pixels of the first modified image.

In some embodiments, one of the predefined encoding operations is to convert the pixel value into a complement number of the pixel value (referred to as third predefined encoding operation hereinafter). For example, the image content server 2 may convert an 8-bit pixel value of 00000111 to 11111000 in the third predefined encoding operation. In some embodiments, the third predefined encoding operation may be performed on some of the pixel values of the image pixels of the first modified image.

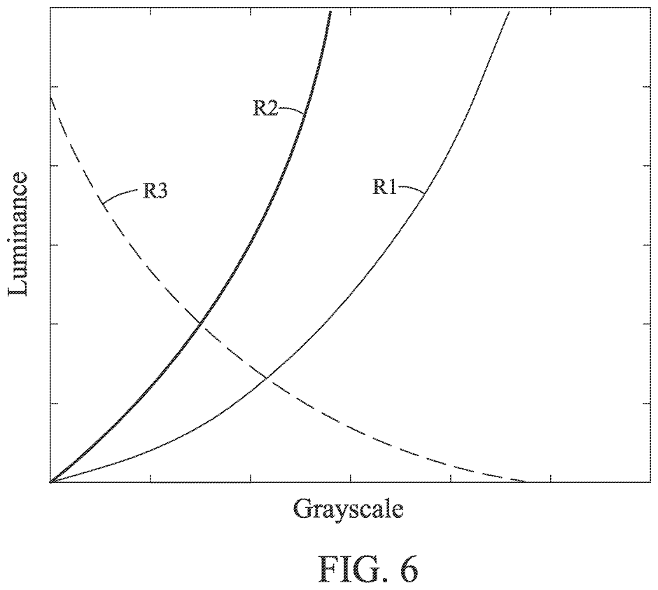

In some embodiments, one of the predefined encoding operations is to map the pixel value to another pixel value based on a predefined mapping relationship or mapping table (referred to as fourth predefined encoding operation hereinafter). In this approach, the predefined mapping relationship/table may be configured to make a display pixel, which actually has the native voltage-luminance relationship, appear to have a modified grayscale-luminance relationship (that is defined with respect to the source image) that is very different from the predetermined grayscale-luminance relationship (which is also defined with respect to the source image), so the resultant second modified image would be so different from the source image that the user will not easily recognize the original content of the source image. As exemplified in FIG. 6, the predetermined grayscale-luminance relationship is represented by a curve R1, and the modified grayscale-luminance relationship can be either a curve R2, a curve R3, or any other suitable grayscale-luminance relationship. In some embodiments, the fourth predefined encoding operation may be performed on some of the pixel values of the image pixels of the first modified image.

In some embodiments, one of the predefined encoding operations is to reverse the order of bits of the pixel value in binary (referred to as fifth predefined encoding operation hereinafter). For example, the image content server 2 may reverse the order of bits of an 8-bit pixel value of 10010111 to obtain 11101001 in the fifth predefined encoding operation. In some embodiments, the fifth predefined encoding operation may be performed on some of the pixel values of the image pixels of the first modified image.

In some embodiments, each of the image pixels corresponds to one of the display-related random factors of the device information that respectively correspond to the display pixels of the display screen 10 since the image pixels have positional correspondences to the display pixels, and the image content server 2 may determine the pixel modification rule for each of the image pixels of the first modified image based on the corresponding one of the display-related random factors. In one example, assuming that the display-related random factors are related to the distributions or combinations of the native voltage-luminance relationships, the image content server 2 may classify the image pixels into multiple groups based on, for example but not limited to, differences between a reference voltage-luminance relationship (which can be one of the native voltage-luminance relationships or the desired voltage-luminance relationship) and the native voltage-luminance relationships, and determine different pixel modification rules respectively for different groups. In one example, assuming that the display-related random factors are the random numbers generated by the random number generator of the display screen 10, the image content server 2 may classify the image pixels into multiple groups based on, for example but not limited to, a remainder of a division of the corresponding random number by a predetermined positive integer, and then determine different pixel modification rules respectively for different groups. For example, the image pixels may be classified into four groups by dividing the random numbers by four, which will result in four possible remainders (i.e., 0, 1, 2 and 3). Because the image pixels are classified based on the display-related random factors, distribution of the pixel modification rules with respect to the image pixels would be random, thereby enhancing complexity of the encoding and data security.

As an example, the pixel modification rule to be performed on the image pixels in one of the groups may be a combination of the first predefined encoding operation and the second predefined encoding operation, the pixel modification rule to be performed on the image pixels in another one of the groups may be a combination of the first predefined encoding operation and the fourth predefined encoding operation, and the pixel modification rule to be performed on the image pixels in yet another one of the groups may be a combination of the second predefined encoding operation, the third predefined encoding operation and the fourth predefined encoding operation.

Referring to FIGS. 1, 2 and 4 again, in step S6, the image content server 2 transmits the second modified image to the eyeglasses display device 1 through the data transceiving device 3.

In step S7, the eyeglasses display device 1 receives the image modification instruction, and acquires the information related to the image modification rule from the image modification instruction. In this embodiment, the eyeglasses display device 1 includes a decoder circuit 11 (see FIG. 3) that is located on the display screen 10, and that is capable of performing multiple decoding operations that respectively correspond to the predefined encoding operations. Using hardware (i.e., the decoder circuit 11) to perform the decoding operations is advantageous in that, in comparison to software decoding, it is much more difficult and higher cost for one who wants to pirate images to find out about algorithms of the decoding operations because reverse engineering of the decoder circuit 11 is required. The decoder circuit 11 may include adders, logic gates, registers, etc., to realize the decoding operations. Since design of the decoder circuit 11 depends on the predefined encoding operations that are used by the image content server 2 to convert the first modified image into the second modified image, this disclosure is not limited to specific circuit structures for the decoder circuit 11. In practice, the image modification instruction may include a set of training signals that are related to the image modification rule to train the decoder circuit 11, so that the decoder circuit 11 learns the image modification rule, and selects, for each of the image pixels of the second modified image, some of the decoding operations that correspond to the combination of those of the predefined encoding operations applied to the corresponding image pixel of the first modified image, where the selected decoding operations are to be performed on the image pixel of the second modified image. As an example, the training signals may be hidden in the data signal of the second modified image (e.g., adding additional bits that represent the pixel modification rules for the image pixels into the data of the second modified image), so the decoder circuit 11 can perform corresponding decoding operation, but this disclosure is not limited to such. Because the decoder circuit 11 is located on the display screen 10 of the eyeglasses display device 1, even though the data transceiving device 3 also receives the second modified image during the transmission of the second modified image from the image content server 2 to the eyeglasses display device 1, one cannot use the data transceiving device 3 to watch or obtain the image content of the source image or the first modified image because the second modified image is made drastically different from the first modified image, and unauthorized copy of the image content of the source image can thus be prevented.

In step S8, the eyeglasses display device 1 receives the second modified image, and uses the decoder circuit 11 that has been trained in step S7 to convert the second modified image back to the first modified image. Since the decoder circuit 11 is located on the display screen 10, if a person wants to pirate the image content by intercepting transmission of the image content to the display screen 10, he/she can acquire only the second modified image, which is made so different from the source image that one cannot easily recognize the original content of the source image, so the piracy becomes meaningless. Even if the person tries to decode the second modified image, he/she is likely to fail because the image modification rule involves the display-related random factors that have no rules to follow.

In step S9, the eyeglasses display device 1 uses the display screen 10 to display the first modified image. Since the difference between the first modified image and the source image (i.e., the data change introduced into the source image) is made so small that one cannot notice the difference with the naked eyes, the user's viewing experience will not be affected. However, if the first modified image is pirated, the content provider may use the data change to identify a source from which the first modified image was leaked (i.e., the eyeglasses display device 1 or a device group that includes the eyeglasses display device 1 (one of the groups that the device information of the eyeglasses display device 1 is classified into) because the data change is made based on the device information, which is unique to each display device. As a result, the person who pirated the first modified image may be located based on the identified source.

In summary, the embodiment of the copy-protected image display system according to this disclosure introduces a small data change into the source image to obtain the first modified image, and applies a significant modification to the first modified image to obtain the second modified image. Since the decoder circuit 11 is located on the display screen 11, one cannot obtain the first modified image or the source image from the data transceiving device 3, thereby increasing difficulty in obtaining an unauthorized copy of the image content. Furthermore, since the decoding operations are performed using hardware, namely the decoder circuit, finding the decoding algorithm will be much harder, higher cost, and more time consuming in comparison to software decoding, so any motivation to pirate may be reduced. Even if the decoding algorithm of the decoder circuit is found and the pirate of the image content is successful in converting the second modified image back to the first modified image, the content provider can easily identify the source from which the first modified image is leaked based on the difference between the first modified image and the source image, and eventually locate the pirate of the image content. Furthermore, since the aforesaid predefined encoding operations do not involve complex computations but only simple operations such as addition, subtraction, bit shifting, etc., the decoding operations can be performed by the decoder circuit 11 that is specifically designed with respect to the predefined encoding operations, and the eyeglasses display device 1 need not include a processor, so power consumption and material cost of the eyeglasses display device 1 can be reduced.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A copy-protected image display system adapted for use with a data transceiving device to present an image, comprising:
an eyeglasses display device that is configured for image display, the eyeglasses display device being communicatively connected to the data transceiving device; and
an image content server that stores a source image corresponding to a plurality of image pixels and device information of said eyeglasses display device, wherein said image content server is configured to be communicatively connected to the data transceiving device;
wherein said image content server is configured to introduce a data change to the source image based on the device information, so as to obtain a first modified image that corresponds to the image pixels;
wherein, for each of the image pixels, a difference between the first modified image and the source image at the image pixel is smaller than a first threshold pixel value;
wherein, for a first portion of the image pixels, the difference between the first modified image and the source image at each of the image pixels in the first portion is greater than zero;
wherein said image content server is configured to convert the first modified image into a second modified image based on an image modification rule;
wherein, for a second portion of the image pixels, a difference between the second modified image and the first modified image at each of the image pixels in the second portion is greater than a second threshold pixel value that is greater than the first threshold pixel value;
wherein said image content server is configured to transmit the second modified image to said eyeglasses display device through the data transceiving device; and
wherein said eyeglasses display device comprises a decoder circuit that is configured to convert the second modified image back to the first modified image, and is configured to display the first modified image.

2. The copy-protected image display system of claim 1, wherein said image content server is capable of performing a plurality of predefined encoding operations, and to select and combine some of the predefined encoding operations to form the image modification rule;
wherein said image content server is configured to transmit an image modification instruction to said eyeglasses display device through the data transceiving device, the image modification instruction comprising information related to the image modification rule;
wherein said decoder circuit of said eyeglasses display device is capable of performing multiple decoding operations that respectively correspond to the predefined encoding operations, and is configured to, based on the information related to the image modification rule, perform some of the decoding operations that correspond to said some of the predefined encoding operations to convert the second modified image back to the first modified image.

3. The copy-protected image display system of claim 2, wherein the first modified image has a plurality of pixel values that respectively correspond to the image pixels, and the predefined encoding operations include at least one of a first encoding operation, a second encoding operation, a third encoding operation, a fourth encoding operation or a fifth encoding operation;
wherein the first encoding operation is to perform a circular shift on some of the pixel values of the first modified image;
wherein the second encoding operation is to subtract a predetermined value that is greater than the second threshold pixel value from some of the pixel values of the first modified image;
wherein the third encoding operation is to convert some of the pixel values of the first modified image into complement numbers of said some of the pixel values;
wherein the fourth encoding operation is to, for some of the pixel values of the first modified image, map each of said some of the pixel values to another pixel value based on a predefined mapping relationship; and
wherein the fifth encoding operation is to reverse an order of bits of some of the pixel values of the first modified image in binary.

4. The copy-protected image display system of claim 1, wherein the first modified image has a plurality of pixel values that respectively correspond to the image pixels;
wherein said image content server stores a plurality of display-related random factors, and each of the image pixels corresponds to one of the display-related random factors;
wherein the image modification rule comprises, for each of the image pixels, a pixel modification rule that is used to change the corresponding one of the pixel values; and
wherein said image content server is configured to, for each of the image pixels, determine the pixel modification rule for the image pixel based on the corresponding one of the display-related random factors.

5. The copy-protected image display system of claim 4, wherein said eyeglasses display device has a plurality of display pixels that correspond in position to the image pixels, and each of said display pixels has a native voltage-luminance relationship;
wherein each of the image pixels corresponds to the native voltage-luminance relationship of one of said display pixels that corresponds in position to the image pixel;
wherein the device information comprises the native voltage-luminance relationships of said display pixels, and the native voltage-luminance relationships of said display pixels serve as the display-related random factors; and
wherein said image content server is configured to, for each of the image pixels, determine the pixel modification rule for the image pixel based on the native voltage-luminance relationship of said one of said display pixels.

6. The copy-protected image display system of claim 4, wherein said eyeglasses display device has a plurality of display pixels that correspond in position to the image pixels;
wherein said eyeglasses display device comprises a random number generator that is configured to generate random numbers respectively for said display pixels, and said eyeglasses display device is configured to transmit the random numbers along with correspondences between the random numbers and said display pixels to said image content server through the data transceiving device; and
wherein said image content server makes the random numbers serve as the display-related random factors, and is configured to, for each of the image pixels, determine the pixel modification rule for the image pixel based on one of the random numbers that corresponds to one of said display pixels which corresponds in position to the image pixel.

7. The copy-protected image display system of claim 4, wherein said image content server is capable of performing a plurality of predefined encoding operations, and is configured to, for each of the image pixels, select and combine some of the predefined encoding operations based on the corresponding one of the display-related random factors to form the pixel modification rule;
wherein said image content server is configured to transmit an image modification instruction to said eyeglasses display device through the data transceiving device, the image modification instruction comprising information related to the pixel modification rules with respect to the image pixels; and
wherein said decoder circuit of said eyeglasses display device is capable of performing multiple decoding operations that respectively correspond to the predefined encoding operations, and is configured to, based on the information related to the pixel modification rules acquired from the image modification instruction, perform, on each of the image pixels, some of the decoding operations that correspond to said some of the predefined encoding operations of the corresponding one of the pixel modification rules, so as to convert the second modified image back to the first modified image.

8. The copy-protected image display system of claim 7, wherein the predefined encoding operations comprise at least one of a first encoding operation, a second encoding operation, a third encoding operation, a fourth encoding operation or a fifth encoding operation;
wherein the first encoding operation is to perform a circular shift on the corresponding one of the pixel values of the first modified image;
wherein the second encoding operation is to subtract a predetermined value that is greater than the second threshold pixel value from the corresponding one of the pixel values of the first modified image;
wherein the third encoding operation is to convert the corresponding one of the pixel values of the first modified image into a complement number of the corresponding one of the pixel values;
wherein the fourth encoding operation is to map the corresponding one of the pixel values to another pixel value based on a predefined mapping relationship; and
wherein the fifth encoding operation is to reverse an order of bits of the corresponding one of the pixel values of the first modified image in binary.

9. The copy-protected image display system of claim 1, wherein said eyeglasses display device comprises a physically unclonable function (PUF) circuit, and the device information of said eyeglasses display device relates to physical characteristics of the PUF circuit;
wherein said PUF circuit is configured to generate an identification data piece that relates to the physical characteristics of the PUF circuit, and said eyeglasses display device is configured to transmit the identification data piece to said image content server through the data transceiving device; and
wherein said image content server is configured to, upon determining that the identification data piece matches the device information, determine the data change for said eyeglasses display device based on the device information.

10. The copy-protected image display system of claim 1, wherein the device information relates to electric characteristics of said eyeglasses display device, and said eyeglasses display device is configured to generate an identification data piece that relates to the electric characteristics of said eyeglasses display device, and to transmit the identification data piece to said image content server through the data transceiving device; and
wherein said image content server is configured to, upon determining that the identification data piece matches the device information, determine the data change for said eyeglasses display device based on the device information.

11. The copy-protected image display system of claim 1, wherein said eyeglasses display device has a plurality of display pixels each having a native voltage-luminance relationship, and the device information comprises the native voltage-luminance relationships of said display pixels; and
wherein said image content server is configured to introduce the data change to the source image to make each of said display pixels, which has the native voltage-luminance relationship, appear to have a predetermined grayscale-luminance relationship that is defined with respect to the source image.

12. The copy-protected image display system of claim 1, wherein said eyeglasses display device comprises a random number generator to generate a random number corresponding to said eyeglasses display device, and is configured to transmit the random number to said image content server through the data transceiving device; and
wherein the device information comprises the random number provided by said eyeglasses display device, and said image content server is configured to determine the data change for said eyeglasses display device based on the random number.
